(19) United States
(12) Patent Application Publication
(10) Pub. No.: US 2010/0164971 A1
(43) Pub. Date: Jul. 1, 2010

(54) GRAPHICS PROCESSOR

(75) Inventor: Joseph Arthur Harris, West Jordan, UT (US)

Correspondence Address: MADSON IP, Old Shepard Commons, Suite 230, 1466 North Highway 89, Farmington, UT, 84025, US

(73) Assignee: Celio Technology Corporation, Salt Lake City, UT (US)

(21) Appl. No.: 12/648,156

(22) Filed: Dec. 28, 2009

Related U.S. Application Data
(60) Provisional application No. 61/141,098, filed on Dec. 29, 2008.

(51) Int. Cl. G09G 5/36

(52) U.S. Cl. 345/560

(57) ABSTRACT

A graphics processor for processing graphics data originating in a host device into rendered graphics data employable in a remote display device. The graphics processor includes a video processor with a reduced instruction-set computer coupled to a configuration register for producing rendered graphics data from the graphics data in a memory storage structure. A first line buffer affords the video processor read-only access to the graphics data in the memory storage structure, and a second line buffer affords the video processor write access to the memory storage structure for rendered graphics data. A method of processing graphics data includes the steps of moving graphics data from the host device into a memory storage structure, transferring the graphics data from the memory storage structure to the video processor, processing the graphics data in the video processor, and writing the rendered graphics data into the memory storage structure.

### CROSS-REFERENCED RELATED APPLICATIONS

This application claims the benefit and is a continuation-in-part application of U.S. Provisional Patent Application Ser. No. 61/141,098 that was filed on Dec. 29, 2008.

### BACKGROUND OF THE INVENTION

1. Field of the Invention

The present invention relates to electronic data processing systems that present visual images to users. In particular, the present invention pertains to the processing of electronic data about visual images into data that can be employed to display the corresponding images on an electronic device.

2. Background

The miniaturization of electronic circuitry has facilitated the development of numerous hand-held electronic devices, which despite being diminutive in size, embody impressive amounts of computing power and data storage space. Many carry visual displays and, therefore, of necessity process graphics data in such manners that visual images corresponding to that graphics data can be presented to a user. Examples of hand-held devices of this type include cellular phones, smart phones, personal digital assistants, electronic books, and personal media players.

The electronic processing of graphics data into data suitable for use by a display device is referred to generally as the processing of that graphics data, and the results of that processing is called rendered graphics data. As used herein, processing graphics data includes mixing, copying, decoding or other operations for manipulating the graphics data into data suitable for use by a display device.

The processing of graphics data, particularly graphics data for moving images, requires a large number of high-speed computations undertaken on a continuing basis over periods of time that are, when compared to other common types of computing operations, relatively lengthy. Such processing operations accordingly consume amounts of current that are troublesome in devices that are small enough to be handheld. On board power sources in such devices are correspondingly small and easily depleted by extended data processing activity.

### BRIEF SUMMARY OF THE INVENTION

The present invention relieves a processor of the spatial burden and the power drain associated with processing graphics data by employing a dedicated graphics processor. This is accomplished with such efficiency and elegance that the graphics data is processed using a relatively small graphics processor having substantially lower power consumption.

Thus, according to teachings of the present invention, a graphics processor is used for processing graphics data housed in a memory storage structure and originating in a host device into rendered graphics data employable in a display device remote from the host device. The graphics processor includes a video processor, an operational storage medium coupled directly to the video processor, and a parallel-channel data buffering system coupled to the video processor.

The video processor produces rendered graphics data from the graphics data in the memory storage structure. The video processor includes a reduced instruction-set computer coupled to the data buffering system and to a configuration register. The reduced instruction set computer includes an A-register, an X-register, a program counter and a stack pointer and has an instruction set of twenty-seven (27) executable instructions. The operational storage medium of the graphics processor includes a random access memory coupled to the video processor and to the data buffering system.

The data buffering system, which is capable of being coupled directly to the memory storage structure, provides read-only access by the video processor to the graphics data in the memory storage structure and substantially write-only access to the memory storage structure for the rendered graphics data from the video processor. The data buffering system includes a first line buffer and a second line buffer, each being coupled to the video processor and to the memory storage structure. Both the first line buffer and the second line buffer provide read access to the graphics data in the memory storage structure, but the second line buffer further provides write access to the memory storage structure for the rendered graphics data. The first line buffer is capable of reading across line boundaries in the graphics data in the memory storage structure, whereas the second line buffer is not capable of reading across the line boundaries in the graphics data in the memory storage structure. To control operation of the first line buffer and the second line buffer, the data buffering system includes control circuitry coupled to the video processor.

In another aspect of the present invention, the graphics processor is coupled to the memory storage structure and a processor to form an enhancer that is coupleable to a host device. The enhancer processes the graphics data originating in the host device into the rendered graphics data employable in a display device remote from the host device.

In yet another aspect of the present invention, the enhancer is coupled to the host device, forming a graphics system for processing graphics data into rendered graphics data. The host device may be any suitable device, such as a cellular phone, a smart phone, a personal digital assistant, an electronic book and a personal media player. Some instances of the graphics system further include a display device of relatively substantial graphics display capability coupled to the enhancer, which receives the rendered graphics data from the enhancer and exhibits the rendered graphics data. In additional instances of the graphics system, a keyboard of relatively commodious proportions is included. The keyboard is coupled to the enhancer to afford the system operator easier control of the system.

Another aspect of the present invention includes a method for processing graphics data from a host device. Such a method includes the steps of moving the graphics data from the host device into a memory storage structure of an enhancer. The graphics data is transferred from the memory storage structure to a video processor, where the graphics data is processed into rendered graphics data capable of being exhibited by a display device remotely located from the host device. The rendered graphics data is written into the memory storage structure.

The graphics data is transferred from the memory storage structure to the video processor by reading the graphics data from the memory storage structure into a first buffer and communicating the graphics data from the first buffer to the video processor. Additional graphics data is fetched from the memory storage structure into the first buffer and relayed from the first buffer to the video processor. Additionally, destination line graphics data may be transcribed from the memory storage structure into a second buffer and delivered from the second buffer to the video processor. The step of writing the rendered graphics data into the memory storage structure includes the steps of storing the rendered graphics data in the second buffer and passing the rendered graphics data from the second buffer into the memory storage structure.

### BRIEF DESCRIPTION OF THE SEVERAL VIEWS OF THE DRAWINGS

In order that the manner in which the above-recited and other features and advantages of the present invention are obtained will be readily understood, a more particular description of the present invention briefly described above will be rendered by reference to specific embodiments thereof which are illustrated in the appended drawings. Understanding that these drawings depict only typical embodiments of the present invention and are not therefore to be considered to be limiting of scope thereof, the present invention will be described and explained with additional specificity and detail through the use of the accompanying drawings in which:

FIG. 1 is a perspective view of an exemplary embodiment of a system incorporating teachings of the present invention to enable a hand-held device to permit a user to view video images on a display device remote from the hand-held device itself;

FIG. 2 is an overview schematic diagram of selected components of the system of FIG. 1;

FIG. 3 is a schematic diagram interrelating elements of the enhancer in FIG. 2 with each other and with selected elements of the system of FIG. 1;

FIG. 4 is a block diagram depicting in detail the relationship among elements of the graphics processor in the enhancer of FIG. 3; and

FIG. 5 is a flow chart depicting steps in a method embodying teachings of the present invention to process graphics data.

### DETAILED DESCRIPTION OF THE INVENTION

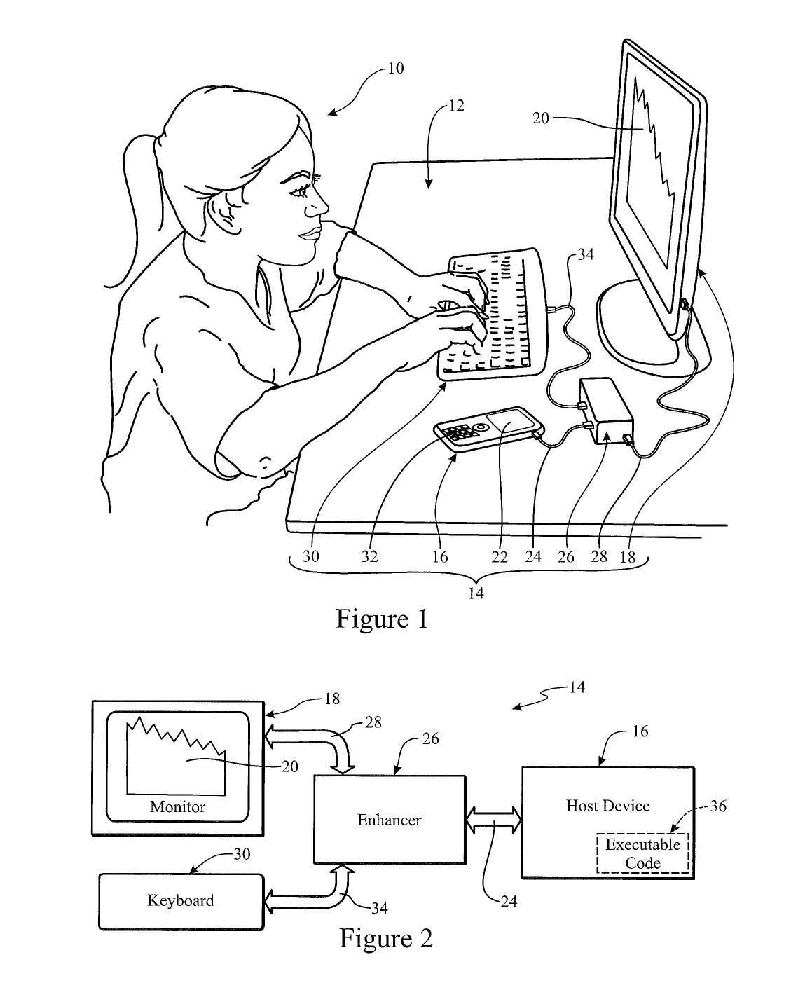

The presently preferred embodiments of the present invention will be best understood by reference to the drawings, wherein like parts are designated by like numerals throughout. It will be readily understood that the components of the present invention, as generally described and illustrated in the figures herein, could be arranged and designed in a wide variety of different configurations. Thus, the following more detailed description of the embodiments of the present invention, as represented in FIGS. 1-5, is not intended to limit the scope of the invention, as claimed, but is merely representative of presently preferred embodiments of the invention.

FIG. 1 depicts a typical environment in which teachings of the present invention find utility. A user 10 at a desk 12 is operating an exemplary embodiment of a system 14 that incorporates teachings of the present invention to enhance selected of the functions routinely available in a hand-held host device 16 that rests on desk 12. Host device 16 is possessed of substantial computing power and data storage space, but due to the small size thereof, host device 16 has limited screen size and is awkward to control. Examples of typical hand-held devices like host device 16 are cellular telephones, smart telephones, personal digital assistants, electronic books, and personal media players.

System 14 enables user 10 to view in enlarged format on a stand-alone monitor 18 an image 20, whereas details of image 20 might otherwise be indiscernible to user 10 when exhibited on the visual display 22 that is built into host device 16.

While graphics data about image 20 originates in host device 16, central to the ability of system 14 to display image 20 on monitor 18, is an enhancer 26 for host device 16 that is a structure distinct from host device 16. As shown in FIG. 1, enhancer 26 communicates with host device 16 on an enhancer cable 24. Nonetheless, enhancer 26 and host device 16 may communicate using a wireless-type of connection. Enhancer 26 processes graphics data about image 20 obtained from host device 16 into rendered graphics data about image 20 that is suitable for presentation on a display device of larger graphics display capability, such as monitor 18. As shown in FIG. 1, the rendered graphics data is communicated from enhancer 26 to monitor 18 on a monitor cable 28. Nonetheless, enhancer 26 and monitor 18 may communicate using a wireless-type of connection. In any case, the task of processing the graphics data into rendered graphics data is carried out by enhancer 26, which is discussed in detail in due course below.

Optionally, included in system 14 is a full-size input device, such as a keyboard 30, which allows user 10 to control system 14 without resorting to the set of miniature keys 32 that is carried directly on host device 16. As shown in FIG. 1, enhancer 26 is electrically coupled to keyboard 30 through a keyboard cable 34. Nonetheless, enhancer 26 and keyboard 30 may communicate using a wireless-type of connection.

FIG. 2 is a schematic diagram of the components of system 14 in FIG. 1. Host device 16 can be seen to be coupled to enhancer 26 by enhancer cable 24, while enhancer 26 is coupled to monitor 18 by monitor cable 28 and to keyboard 30 by keyboard cable 34. Enlarged image 20 is being presented on monitor 18, rather than on the visual display built into host device 16. The graphics data originating in host device 16 is formatted by executable code 36 therein, before being moved to enhancer 26.

Other configurations of the elements of system 14 are considered to be within the scope of the present invention. For example, enhancer 26 can be incorporated with monitor 18 in a single structure that would then be connected by individual cables to each of host device 16 and keyboard 30. Alternatively, enhancer 26 and keyboard 30 can be incorporated into a single structure that is connected by individual cables to each of host device 16 and monitor 18. For maximum simplicity, enhancer 26, monitor 18, and keyboard 30 are combined in a single structure that is coupled to host device 16 by a single cable.

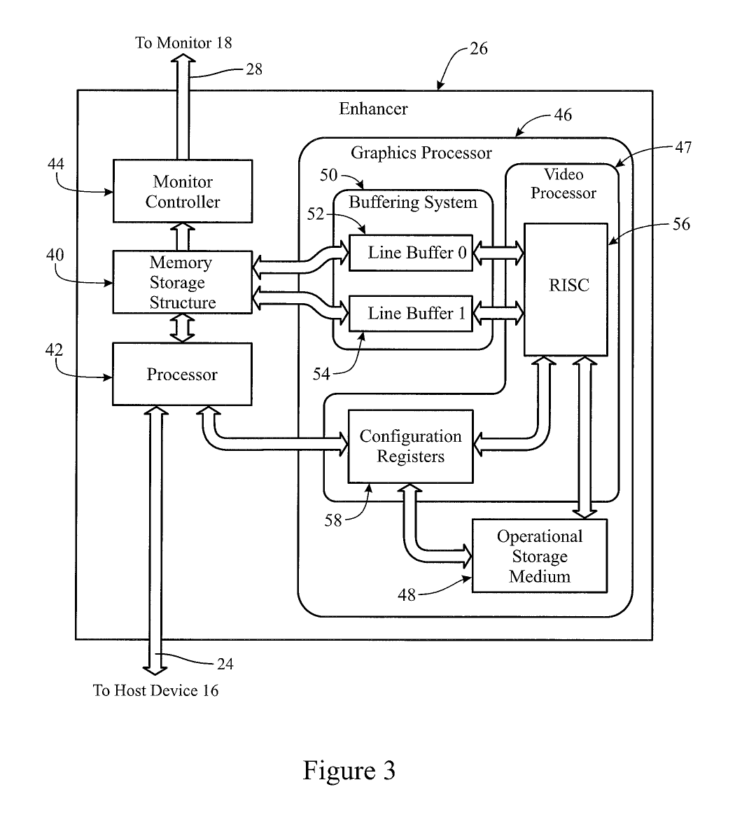

FIG. 3 is a schematic diagram depicting and interrelating selected elements of enhancer 26 from FIG. 2. Enhancer 26 processes graphics data housed in memory storage structure 40 that originated in host device 16 to produce rendered graphics data that is employable in a display device of relatively substantial graphics display capability, such as monitor 18 shown in FIGS. 1 and 2, which is substantially larger than visual display 22 of host device 16. Enhancer 26 includes a memory storage structure 40 and a processor 42 that is coupled to memory storage structure 40 and to host device 16. Memory storage structure 40 is coupled to a monitor controller 44, which in turn communicates with monitor 18 by way of monitor cable 28. Each of memory storage structure 40 and processor 42 of enhancer 26 communicates with various elements of a graphics processor 46 that is also located within enhancer 26.

By way of overview, graphics processor 46 is shown in FIG. 3 as including a video processor 47, an operational storage medium 48, and a data buffering system 50.

Data buffering system 50 is coupled between video processor 47 and memory storage structure 40. Included in data buffering system 50 is a pair of parallel data communication channels between video processor 47 and memory storage structure 40. Data buffering system 50 affords read-only access by video processor 47 to graphics data in memory storage structure 40 and substantially write-only access to memory storage structure 40 for rendered graphics data from video processor 47. Thus, as revealed in FIG. 3, data buffering system 50 includes both a first line buffer 52, which is referred to in the accompanying figures and on occasion in the following text as “Line Buffer 0” and, parallel thereto, a second line buffer 54, which is referred to in the accompanying figures and on occasion in the following text as “Line Buffer 1”. Each of first line buffer 52 and second line buffer 54 is coupled between video processor 47 and memory storage structure 40. First line buffer 52 is a read-only buffer capable of reading across line boundaries in the graphics data in memory storage structure 40. By contrast, second line buffer 54 is a substantially write-only buffer that is incapable of reading across line boundaries in the graphics data in the memory storage structure 40. Second line buffer 54 may be afforded a degree of read-only capability.

Video processor 47 is capable of producing rendered graphics data from the graphics data in memory storage structure 40. To do so, video processor 47 is coupled directly to processor 42, but indirectly by way of buffering system 50 to memory storage structure 40. Included in video processor 47 are a reduced instruction-set computer 56 that is coupled to data buffering system 50 and configuration registers 58 that are coupled between reduced instruction-set computer 56 and processor 42. In the accompanying figures, the expression reduced instruction-set computer is abbreviated as “RISC.” Reduced instruction-set computer 56 is described in more detail below.

In one embodiment of the present invention, operational storage medium 48 is a dual port random access memory of about 4 kilo-bytes in size. Among selected of the accompanying figures, the expression random access memory is abbreviated as “RAM.” Operations storage medium 48 is coupled directly, both to reduced instruction-set computer 56 and to configuration registers 58, each of which is within video processor 46.

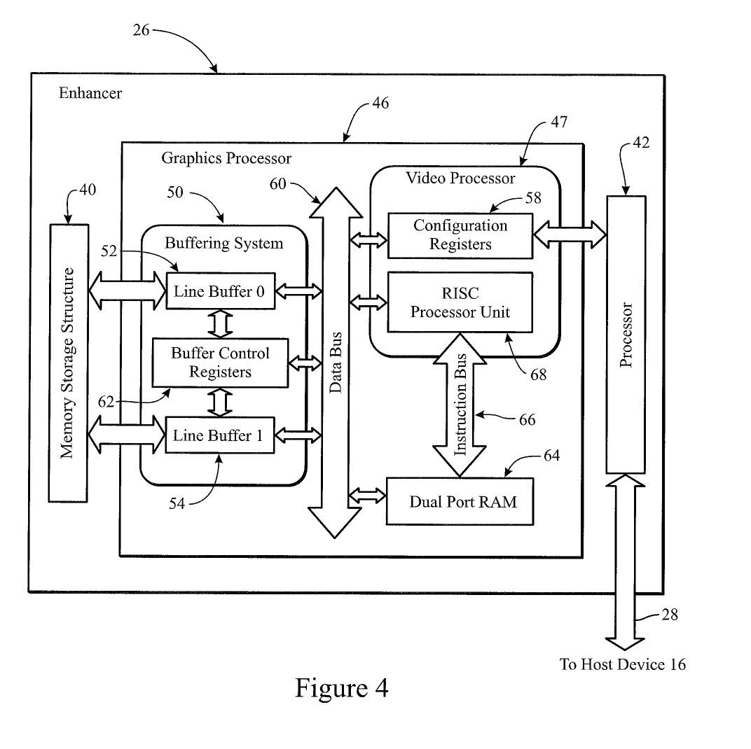

FIG. 4 is a block diagram depicting in some further detail the relationship among elements of graphics processor 46 of FIG. 3, as well as between those elements of graphics processor 46 and other elements of enhancer 26. There, graphics processor 46 can newly be seen to include a data bus 60 by which video processor 47 and buffering system 50 communicate as needed. Buffering system 50 newly includes control circuitry for first line buffer 52 and second line buffer 54 that takes the form of buffer control registers 62. Each of first line buffer 52 and second line buffer 54 is directly coupled to buffer control registers 62, while buffer control registers 62 are also coupled by way of data bus 60 with video processor 47.

In FIG. 4, memory storage structure 48 is presented with additional specificity relative to FIG. 3 as a dual port RAM 64. Dual port RAM 64 communicates directly through an instruction bus 66 with reduced instruction-set computer 56, which is identified in FIG. 4 as RISC processor unit 68.

Configuration registers 58 in video processor 47 communicate out of graphics processor 46 with processor 42 of enhancer 26. First line buffer 52 and second line buffer 54 of data buffering system 50 communicate out of graphics processor 46 with memory storage structure 40 of enhancer 26.

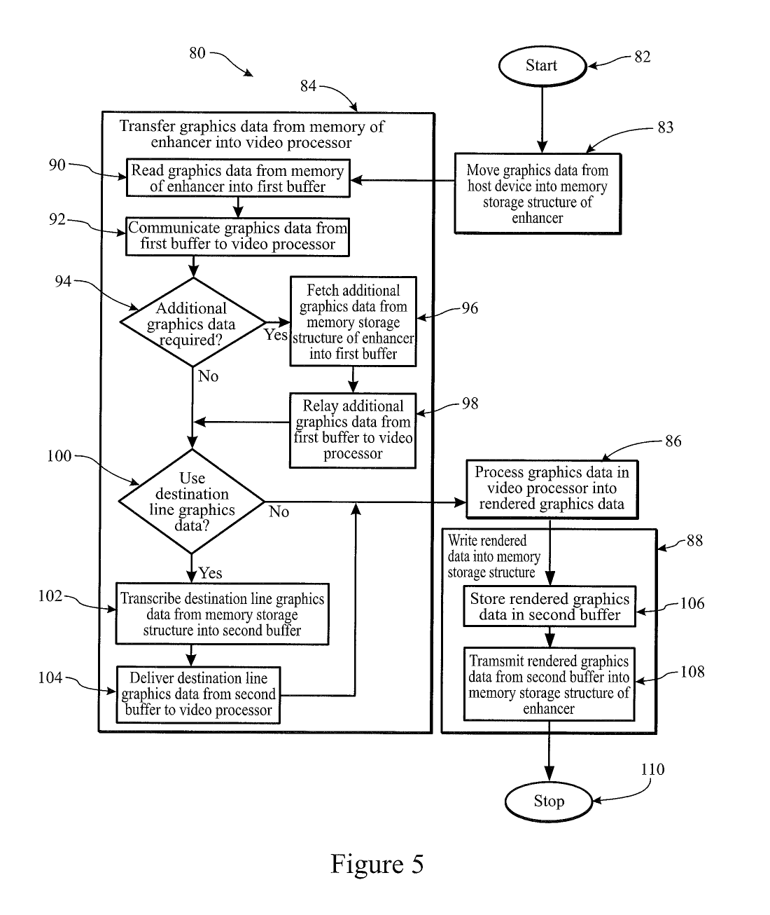

The present invention also includes methods for processing graphics data originating in a host device. One embodiment of such a method 80 is depicted in the flow chart presented in FIG. 5.

Beginning at commencement oval 82, method 80 proceeds first, as indicated in instruction rectangle 83, to move graphics data from the host device into a memory storage structure in an enhancer for the host device. Then in a subroutine 84, method 80 continues by transferring the graphics data from the memory storage structure to a video processor. As indicated in an instruction rectangle 86, method 80 proceeds to process the graphics data in the video processor into rendered graphics data exhibitable by a display device of relatively substantial graphics display capability. As used herein, processing the graphics data in the video processor includes various operations including, for example, rendering, mixing, copying, decoding or otherwise manipulating the graphics data. Finally, method 80 concludes in a subroutine 88 by writing the rendered graphics data into the memory storage structure of the enhancer.

Subroutine 84 commences as indicated in instruction rectangle 90 with the step of reading the graphics data from the memory storage structure of the enhancer into a first buffer and proceeds to the step of communicating the graphics data from the first buffer to the video processor, as indicated in instruction rectangle 92. If the graphics data communicated from the first buffer to the video processor called for in subroutine 92 does not require additional graphics data, then, as indicated in decision diamond 94, subroutine 84 proceeds to the determination of whether to use destination line graphics data called for in decision diamond 100. If, however, the graphics data communicated from the first buffer to the video processor called for in subroutine 92 requires additional graphics data, such as source line graphics data, then method 80 continues to step 96. As indicated in instruction rectangle 96, the step of fetching additional graphics data from the memory storage structure of the enhancer into the first buffer is undertaken, followed by the step of relaying the additional graphics data from the first buffer to the video processor.

Subroutine 84 continues, as indicated in decision diamond 100, by undertaking the step of determining whether to use destination line graphics data. If destination line graphics data is not required, then method 80 proceeds to the processing of graphics data called for in instruction rectangle 86, as indicated in decision diamond 100. On the other hand, if the use of destination line graphics data is required in transfer of graphics data from the memory storage structure of the enhancer into the video processor called for in subroutine 84, then method 80 continues within subroutine 84. As indicated in instruction rectangle 102, the step of transcribing the destination line graphics data from the memory storage structure of the enhancer into the a second buffer is undertaken, followed by the step of delivering the destination line graphics data from the second buffer to the video processor, as indicated in instruction rectangle 104.

Subroutine 88 commences, as indicated in instruction rectangle 106, with the step of storing the rendered graphics data in the second buffer and concludes with the step of transmitting the rendered graphics data from the second buffer into the memory storage structure of the enhancer, as called for in instruction rectangle 108. Thereafter, method 80 concludes at termination oval 110.

System 14 described above results in the highly efficient processing of graphics data. Graphics processor 46 is designed to handle most two-dimensional and some three-dimensional graphic geometries, as well as the decoding of compressed bitmap streams. The architecture of graphics processor 46 requires interconnections to at least two components of the enhancer 26. The first interconnection is to processor 42 shown in FIG. 4. This interconnection provides configuration and control from processor 42 of enhancer 26. The second interconnection is to memory storage structure 40, also shown in FIG. 4. This interface provides access to frame buffer memory, as well as raster operation command memory.

The function of graphics processor 46 is to interpret graphics data, such as raster operation commands, and process those raster commands in frame buffer memory. Raster commands may be communicated as data packets of processing instructions originating in host device 16, which will for convenience hereinafter be referred to as “ROP's”. It is important to distinguish ROP's from the internal instructions in the instruction set in RISC 56 in FIG. 3 that are executed by video processor 47. In particular, the video processor 47 executes the internal code from the 4 kilo-byte random access memory in operation storage medium 48 to read and perform the raster commands contained in each ROP.

Each of the ROP's includes a 16-byte header and a variable length payload that will be referred to as the extended data of the corresponding ROP. The ROP header includes three components. First, each ROP header includes an initial one-byte field for the ROP-identifier, which is also used as the name of the corresponding ROP. Second, following the ROP-identifier, each ROP header includes a three-byte field that indicates the size of the extended data in the ROP that follows the header. The size given in this field of the ROP header does not include the size of the ROP header itself. When a ROP includes no extended data, the size given in this field is zero. Finally, each ROP header concludes with a 12-byte field of ROP-specific parameters.

To reduce overhead on processor 42 of enhancer 26, ROP's can be organized back-to-back in memory storage structure 40, and graphics processor 46 can continuously process raster commands without the intervention of processor 42. The interpretation of the raster commands is done by a small program that resides in the 4 kilo-byte random access memory in operational storage medium 48 in FIG. 3 and that executes on RISC processor unit 68 of video processor 47. A datasheet for RISC processor unit 68 follows in tabular form in due course. Graphics processor 46 uses multiple line buffers, such as Line Buffer 0 and Line Buffer 1, to store raster commands and horizontal lines of frame buffer memory. Pixels in these line buffers are manipulated by RISC processor unit 68 before being written back to frame buffer memory.

RISC processor unit 68 is the actual processing core within video processor 47. RISC processor unit 68 is a small reduced instruction-set computer processor that is optimized to read, modify, and write memory for the purpose of processing the two-dimensional and three-dimensional graphics on an enhancing device, such as monitor 18, that is coupled to enhancer 26 in communication with an enhanced device, such as host device 16, in such a manner that one or more features of the enhancing device are made available to the enhanced device. RISC processor unit 68 functions on conventional Harvard architecture, using a data bus 60 and a separate and distinct instruction bus 66 in FIG. 4. The data bus 60 includes 16-bits, while the instruction bus 66 includes 18-bits. This asymmetry takes advantage of the parity bits available in field programmable gate array block random access memories and allows operation codes to contain a full 16-bit immediate value. Addresses in the operation codes contain 12-bits. RISC processor unit 68 receives the internal code from dual port RAM 64 through instruction bus 66, and uses data bus 60 to communicate with configuration registers 58, buffer control registers 62, Line Buffer 0, Line Buffer 1, and dual port RAM 64.

RISC processor unit 68 is a 16-bit custom, reduced instruction-set computer processor that has only 27 instructions, thereby to limit logic size and complexity, resulting in a substantially smaller physical size and substantially reduced power requirement. Those instructions are mostly single-cycle executions and are stored in dual port random access memory 64. Accordingly, RISC processor unit 68 may be substantially reduced in size, comprising only 615 field programmable gate array slices. RISC processor unit 68 has an accumulator (hereinafter referred to as “the A-register”), an X-register, a program counter (hereinafter referred to as “the PC”), and a stack pointer (hereinafter referred to as “the SP”). RISC processor unit 68 does not have a carry-flag or an overflow-flag, but RISC processor unit 68 does include an I-flag that is an interrupt enable flag.

Table 1 below presents the set of 27 instructions employed in RISC processor unit 68.

TABLE 1
Instruction Set

| Instruction | OP Code | Description | Cycles |
|---|---|---|---|
| lxi | 2[IMM]h | X = [IMM] | 1 |
| js | 18[ADDR]h | PC = [ADDR], SP−− | 3 |
| jz | 19[ADDR]h | If A == 0 then PC = [ADDR] | 3 |
| jmp | 1A[ADDR]h | PC = [ADDR] | 3 |
| lar | 14[ADDR]h | A = RAM[ADDR] | 3 |
| sar | 15[ADDR]h | RAM[ADDR] = A | 3 |
| lxr | 12[ADDR]h | X = RAM[ADDR] | 1 |
| sxr | 13[ADDR]h | RAM[ADDR] = X | 1 |
| and | 04001h | A = A and X | 1 |
| or | 04002h | A = A or X | 1 |
| not | 04004h | A = !A | 1 |
| xor | 04008h | A = A xor X | 1 |
| sub | 04010h | A = A − X | 1 |
| add | 04020h | A = A + X | 1 |
| rl4 | 04040h | A = A rotated left 4 bits | 1 |
| rl1 | 04080h | A = A rotated left 1 bit | 1 |
| rr4 | 04100h | A = A rotated right 4 bits | 1 |
| rr1 | 04200h | A = A rotated right 1 bit | 1 |
| swp | 06400h | A = X, X = A | 1 |
| cli | 08000h | I = 0 | 1 |
| sei | 08001h | I = 1 | 1 |
| pusha | 04800h | RAM[SP] = A, SP−− | 3 |
| popa | 05000h | A = RAM[SP], SP++ | 3 |
| pushx | 02800h | RAM[SP] = X, SP−− | 3 |
| popx | 03000h | X = RAM[SP], SP++ | 3 |
| ji | 10000h | I = 0, PC = [IADDR],SP−− | 4 |
| jr | 11000h | I = RAM[SP], PC = RAM[SP], SP++ | 4 |

RISC processor unit 68 uses the 4 kilo-byte random access memory of dual port RAM 64 for program space, random access memory, and hardware stacking. The stack pointer resets to the top of the random access memory and decrements from there. Random access memory location 000h is reserved for the RESET-vector, which indicates where the program used by RISC processor unit 68 starts executing. A jump instruction causes the stack pointer to move to where that main program starts. Random access memory location 002h is reserved for the INTERRUPT-vector. When an interrupt occurs, RISC processor unit 68 executes the jump instruction, which loads the jump address from this location in the random access memory. The interrupt is ignored if the I-flag is not set. The I-flag is reset to zero, but may be set or cleared using the SEI-instruction and the CLI-instruction.

Table 2 below is a map of the functional locations in dual port RAM 64.

TABLE 2
Memory Map

| Address Location | Function |
|---|---|
| 0000h | RESET vector |
| 0002h | INTERRUPT vector |
| 0004h-003Fh | RAM space |
| 0040h-0EFFh | Code space |
| 0F00h-0FFFh | Stack space |
| 1000h-102Fh | Register space |

Configuration registers 58 shown in FIG. 4 are readable and writable both by processor 42 in enhancer 26 and by RISC processor unit 68. According to some embodiments, the configuration registers 58 may be found in a portion of operational storage medium 48. Configuration registers 58 includes three 32-bit registers identified individually as the CONFIG-register, the STATUS-register, and the ORIGIN-register. These registers are 32-bit, because the data width on the bus coupling the configuration registers 58 to the processor 42 is also 32-bits. The data width of video processor 47 is 16-bits, however, and accordingly the upper and lower 16-bits are available at different addresses. The CONFIG-register enables video processor 47, sets all execution modes, and provides a memory pointer to identify the location of raster operation commands in memory storage structure 40. The STATUS-register contains information on the completion of raster operations, including the ROP-number of each completed raster operation, information on whether any errors were encountered during the raster operation, and an error code when any error was encountered. The ORIGIN-register advises video processor 47 of the location in memory storage structure 40 at which to draw each rendered object.

As seen in FIG. 4, video processor 47 has two full line length buffers that are used to read and to write to memory storage structure 40 shown in enhancer 26. Each buffer is a dual port random access memory that is 512×32 on one side and 1024×16 on the other. The 32-bit side of the random access memory in each buffer connects to memory storage structure 40. The 16-bit side of the random access memory in each buffer connects to data bus 60 that is internal to graphics processor 46. Each port on each buffer has an address pointer and an end pointer, the later being used to indicate when to stop reading or writing. To conserve logic the function of Line Buffer 0 and Line Buffer 1 differ slightly.

Line Buffer 0 is designed to be a read-only buffer. Line Buffer 0 can read across line boundaries. Thus, Line Buffer 0 can undertake reads that go beyond the end of the line increment, the Y-pointer, and wrap around to the other side. Line Buffer 1 is designed to be a read-and-write buffer. Line Buffer 1 can read from memory storage structure 40, but Line Buffer 1 is primarily used to write to memory storage structure 40. Line Buffer 1 cannot cross line boundaries. Operations that require the destination line to be mixed with the source line may, for example, read the destination line graphics data into Line Buffer 1, read the source line graphics data into Line Buffer 0, mix Line Buffer 0 with Line Buffer 1, place the result of the mix back into Line Buffer 1, and then write the result of the mix to memory storage structure 40 from Line Buffer 1.

Buffer control registers 62 are 16-bits wide, serving to configure both Line Buffer 0 and Line Buffer 1 and to enable reading and writing to memory storage structure 40. Buffer control registers 62 control direct memory access logic in order to read and to write continuous memory from memory storage structure 40.

Table 3A below presents descriptions of selected of buffer control registers 62.

TABLE 3A
Buffer Control Registers, Part I

| | Bit | |
|---|---|---|
| Register Name | Number | Function |
| BUFF_CONFIG | 0 | Causes all buffer control registers to reset. |
| | 1 | Causes parity bits on Buffer 1 to clear for current address |
| | | pointer on memory side of buffer 1. |
| | 2 | Allows color register to update on each write to Buffer 1. |
| | 3 | Converts color data from 15 bits to 16 bits. |
| | 4 | Enables writes from data bus to Buffer 1. |
| | 5-7 | Reserved. |
| | 8 | Enables address pointer to Buffer 1 on memory side to |
| | | increment with each read cycle. |
| | 9 | Enables address pointer to Buffer 1 on memory side to |
| | | increment with each write cycle. |
| | 10 | Reserved. |
| | 11 | Enables address pointer to buffer 0 on memory side to |
| | | increment with each read cycle. |
| | 12 | Enables swapping bytes in each word when reading from |
| | | Buffer 0. |
| | 13 | Enables swapping words when reading data from Buffer 0. |
| | 14 | Enables writing to memory from Buffer 1. |
| | 15 | Enables reading from memory into Buffer 0. |
| IRQ | 0-11 | Reserved |
| | 12 | Enables interrupt to assert when Buffer 1 pointer equals |
| | | Buffer 1 end pointer. |
| | 13-15 | Reserved. |
| COLOR | 0-15 | Contains color when used to do run length decoding. |
| REPEAT | 0-15 | Contains repeat value when doing run length decoding. |
| | | When set to non-zero value, Buffer Control Logic continues |
| | | to write color located in COLOR register for number of |
| | | times in the REPEAT register, each time decrementing the |
| | | value in the REPEAT register until zero. |

Table 3B below presents descriptions of additional of buffer control registers 62.

TABLE 3B
Buffer Control Registers, Part II

| | Bit | |
|---|---|---|
| Register Name | Number | Function |
| BUFF0_PTR32 | 0-15 | Pointer to memory side on Buffer 0. |
| BUFF0_Y32 | 0-15 | Selects line number when buffer 0 reads in a line. |
| BUFF0_MAX32 | 0-15 | Contains X component of end pointer for Buffer 0. |
| BUFF0_MAXY32 | 0-15 | Contains Y component of end pointer for Buffer 0. |
| BUFF0_PTR16 | 0-15 | Contains pointer for data bus side on Buffer 0. |
| BUFF0_DATA | 0-15 | Reads data from Buffer 0. Each read from this register |
| | | causes BUFF0_PTR16 to increment. |
| BUFF1_PTR32 | 0-15 | Pointer to memory side on Buffer 1. |
| BUFF1_MAX32 | 0-15 | Contains X component of the end pointer for Buffer 1. |
| | | [NOTE; Disclosure says BUFFER 0. Which one is |
| | | correct?] |
| BUFF1_Y32 | 0-15 | Contains Y component of the pointer for Buffer 1. |
| BUFF1_PTR16 | 0-15 | Contains pointer for data bus side on Buffer 1. |
| BUFF1_MAX16 | 0-15 | Contains end pointer for data bus side on Buffer 1. |
| BUFF1_DATA | 0-15 | Reads/writes data to/from Buffer 1. If Riscbuff1_en16 bit set |
| | | in BUFF_CONFIG register, BUFF1_PTR16 increments with |
| | | each write to this register. |
| BUFF1_DATA2 | 0-15 | Writing to this register when Riscbuff1_en16 bit is set causes |
| | | BUFF1_PTR16 to increment and sets parity bit to mask off |
| | | a write to memory at location pointed to by BUFF1_PTR16. |

Line Buffer 0 performs the purposes of fetching ROP headers, fetching ROP extended data, and fetching source lines. An outline of the steps required to read from memory storage structure 40 into Line Buffer 0 is included below. The only information required to commence that process is StartX, StartY, EndX, and EndY. The distance between StartXY and EndXY cannot be greater than the size of Line Buffer 0. The required steps follow:
1. Write StartX into Buff0_PTR32;
2. Write StartY into Buff0_Y32;
3. Write EndX into Buff0_MAX32;
4. Write EndY into Buff0_MAXY32;
5. Set Config_mch_read and Mchbuff0_rena32 in the BUFF_CONFIG-register; and
6. Poll the BUFF_CONFIG register until Mchbuff0_ren32 clears, indicating that the read from memory storage structure 40 into Line Buffer 0 is complete.

Line Buffer 1 is primarily used for writing to memory storage structure 40, but is also commonly used to read from memory storage structure 40 when doing an operation that requires modifying the destination line. Reading into Line Buffer 1 is similar to reading into Line Buffer 0, but Line Buffer 1 cannot read beyond a line boundary and wrap around in the manner that Line Buffer 0 is able. Therefore, StartY and EndY are the same. An outline of the steps required to read from memory storage structure 40 into Line Buffer 1 is included below. The required steps follow:
1. Write StartX into Buff1_PTR32;
2. Write StartY/EndY into Buff1_Y32;
3. Write EndX into Buff1_MAX32;
4. Set Config_mch_read and Mchbuff1_ren32 in the BUFF_CONFIG-register; and
5. Poll the BUFF_CONFIG-register until Mchbuff1_ren32 clears, indicating that the read from memory storage structure 40 into Line Buffer 1 is complete.

Line Buffer 0 cannot write to memory storage structure 40.

As with reading, Line Buffer 1 cannot write beyond a line boundary. Therefore, StartY and EndY are the same. An outline of the steps required to write to memory storage structure 40 from Line Buffer 1 is included below. The required steps follow:
1. Write StartX into Buff1_PTR32;
2. Write StartY/EndY into Buff1_Y32;
3. Write EndX into Buff1_MAX32;
4. Set Config_mch_write and MchBuff1_wen32 in the BUFF_CONFIG-register; and
5. Poll BUFF_CONFIG register until MchBuff1_wen32 clears, indicating that the write into memory storage structure 40 from Line Buffer 1 is complete.

A graphics processor, such as graphics processor 46, presents several advantages. Using graphics processor 46 it is possible to off-load from the processor in an enhancer the power-intensive activity of processing graphics data originating from a hand-held device into rendered graphics data. This permits the use in the enhancer of a processor of lower cost that has less intensive power consumption. Graphics processor 46, for example, requires only 615 field programmable gate array slices and only four block random access memory structures in order to operate successfully at 100 MHz. The small size and efficient architecture employed in a graphics processor incorporating teachings of the present invention, eliminates any need to employ in an enhancer, such as enhancer 26, any sizeable processor that runs at high speeds in processing graphics data and consumes disadvantageous amounts of power. The small size of a graphics processor incorporating teachings of the present invention accordingly adds little cost to the overall cost associated with processing graphics data.

The present invention may be embodied in other specific forms without departing from its structures, methods, or other essential characteristics as broadly described herein and claimed hereinafter. The described embodiments are to be considered in all respects only as illustrative, and not restrictive. The scope of the invention is, therefore, indicated by the appended claims, rather than by the foregoing description. All changes that come within the meaning and range of equivalency of the claims are to be embraced within their scope.

What is claimed is:

1. A graphics processor for processing graphics data housed in a memory storage structure and originating in a host device into rendered graphics data employable in a display device of remote from the host device, the graphics processor comprising:
(a) a video processor capable of producing rendered graphics data from the graphics data in the memory storage structure;
(b) an operational storage medium coupled directly to the video processor;
(c) a first line buffer coupled to the video processor and coupleable to a memory storage structure, the first line buffer being a read-only buffer; and
(d) a second line buffer coupled to the video processor and coupleable to the memory storage structure, the second line buffer being a substantially write-only buffer.

2. A graphics processor as recited in claim 1, wherein the first line buffer is capable of reading across line boundaries in the graphics data in the memory storage structure.

3. A graphics processor as recited in claim 1, wherein the second line buffer includes a limited read-only capability.

4. A graphics processor as recited in claim 3, wherein the second line buffer is incapable of reading across line boundaries in the graphics data in the memory storage structure.

5. A graphics processor as recited in claim 1, further comprising control circuitry for the first line buffer and for the second line buffer, the control circuitry being coupled to the video processor.

6. A graphics processor as recited in claim 1, wherein the operational storage medium comprises a random access memory coupled to the video processor and to the data buffering system.

7. A graphics processor as recited in claim 1, wherein the video processor comprises:
(a) a reduced instruction-set computer coupled to the data buffering system; and
(b) configuration registers coupled to the reduced instruction-set computer.

8. A graphics processor for processing graphics data housed in a memory storage structure and originating in a host device into rendered graphics data employable in a display device remote from the host device, the graphics processor comprising:
(a) a video processor capable of producing rendered graphics data from the graphics data in the memory storage structure, the video processor comprising:
(i) a reduced instruction-set computer; and
(ii) configuration registers coupled to the reduced instruction-set computer;
(b) an operational storage medium coupled directly to the video processor; and
(c) a parallel-channel data buffering system coupled between the video processor and the memory storage structure, the data buffering system affording read-only access by the video processor to the graphics data in the memory storage structure and substantially write-only access to the memory storage structure for the rendered graphics data from the video processor.

9. A graphics processor as recited in claim 8, wherein the reduced instruction-set computer comprises an instruction set consisting of 27 executable instructions.

10. A graphics processor as recited in claim 8, wherein the reduced instruction-set computer comprises an A-register, an X-register, a program counter and a stack pointer.

11. A graphics processor as recited in claim 8, wherein the data buffering system comprises:
(a) a first line buffer coupled to the video processor and coupleable to the memory storage structure, the first line buffer being a read-only buffer; and
(b) a second line buffer coupled to the video processor and coupleable to the memory storage structure, the second line buffer being a substantially write-only buffer.

12. A graphics processor as recited in claim 11, wherein the second line buffer includes a read-only capability.

13. An enhancer for a host device capable of processing graphics data originating in the host device into rendered graphics data employable in a display device remote from the host device, the enhancer comprising:
(a) a memory storage structure for housing the graphics data generated in the host device;
(b) a processor coupled to the memory storage structure and to the host device, the processor comprising:
(i) a reduced instruction-set computer coupled to the data buffering system; and
(ii) configuration registers coupled between the reduced instruction-set computer and the processor;
(c) a video processor coupled directly to the processor, the video processor being capable of producing from the graphics data in the memory storage structure rendered graphics data employable in a display device;
(d) an operational memory storage medium coupled directly to the video processor;
(e) a parallel-channel data buffering system coupled between the video processor and the memory storage structure, the data buffering system affording read-only access by the video processor to the graphics data in the memory storage structure and substantially write-only access to the memory storage structure for the rendered graphics data from the video processor.

14. An enhancer as recited in claim 13, wherein the data buffering system comprises:
(a) a first line buffer coupled between the video processor and the memory storage structure, the first line buffer being a read-only buffer; and
(b) a second line buffer coupled between the video processor and the memory storage structure, the second line buffer being a substantially write-only buffer.

15. An enhancer as recited in claim 14, wherein:
(a) the first line buffer is capable of reading across line boundaries in the graphics data in the memory storage structure; and
(b) the second line buffer is incapable of reading across line boundaries in the graphics data in the memory storage structure.

16. A system for processing graphics data into rendered graphics data, the system comprising:
(a) a host device containing executable code for generating the graphics data;
(b) an enhancer for the host device coupled thereto, the enhancer comprising:
(i) a memory storage structure for housing the graphics data generated in the host device;
(ii) a processor coupled to the memory storage structure and to the host device;
(iii) a video processor coupled directly to the processor, the video processor being capable of producing from the graphics data in the memory storage structure rendered graphics data employable in a display device;
(iv) an operational storage medium coupled directly to the video processor;
(v) a first line buffer coupled between the video processor and the memory storage structure, the first line buffer being a read-only buffer; and
(iv) a second line buffer coupled between the video processor and the memory storage structure, the second line buffer being a substantially write-only buffer.

17. A system as recited in claim 16, wherein the first line buffer is capable of reading across line boundaries in the graphics data in the memory storage structure.

18. A system as recited in claim 16, wherein the second line buffer is incapable of reading across line boundaries in the graphics data in the memory storage structure.

19. A system as recited in claim 16, further comprising a display device remote from the host device and coupled to the enhancer, the display device being capable of exhibiting the rendered graphics data.

20. A system as recited in claim 16, further comprising a keyboard of relatively commodious proportions coupled to the enhancer, affording an operator of the system easier control of the system than the control of the system afforded by the input capability of the host device.

21. A system as recited in claim 16, wherein the host device comprises a device selected from the group of devices comprising a cellular phone, a smart phone, a personal digital assistant, an electronic book, and a personal media player.

22. A method for processing graphics data from a host device, the method comprising the steps of:
(a) moving the graphics data from the host device into a memory storage structure;
(b) transferring the graphics data from the memory storage structure to a video processor;
(c) processing the graphics data in the video processor into rendered graphics data exhibitable by a display device remotely located from the host device; and
(d) writing the rendered graphics data into the memory storage structure.

23. A method as recited in claim 22, wherein the step of transferring comprises the steps of:
(a) reading the graphics data from the memory storage structure into a first buffer; and
(b) communicating the graphics data from the first buffer to the video processor.

24. A method as recited in claim 23, wherein the step of transferring further comprises the steps of:
(a) fetching additional graphics data from the memory storage structure into the first buffer; and
(b) relaying the additional graphics data from the first buffer to the video processor.

25. A method as recited in claim 23, wherein the step of transferring further comprises the steps of:
(a) transcribing destination line graphics data from the memory storage structure into a second buffer; and
(b) delivering the destination line graphics data from the second buffer to the video processor.

26. A method as recited in claim 22, wherein the step of writing comprises the steps of:
(a) storing the rendered graphics data in the second buffer; and
(b) passing the rendered graphics data from the second buffer into the memory storage structure.
